(19) United States
(12) Patent Application Publication
(10) Pub. No.: US 2016/0216457 A1
(43) Pub. Date: Jul. 28, 2016

(54) OPTICAL COUPLING APPARATUS INCLUDING OPTICAL TRANSMITTING AND RECEIVING MODULE

(71) Applicant: ELECTRONICS AND TELECOMMUNICATIONS RESEARCH INSTITUTE, Daejeon-si (KR)

(72) Inventors: Sae Kyoung KANG, Daejeon-si (KR); Jun Ki LEE, Daejeon-si (KR); Joon Young HUH, Daejeon-si (KR); Jong Hyun LEE, Daejeon-si (KR)

(21) Appl. No.: 15/006,297

(22) Filed: Jan. 26, 2016

(30) Foreign Application Priority Data
Jan. 28, 2015 (KR) 10-2015-0013767

(51) Int. Cl. G02B 6/38; G02B 6/27; G02B 1/11

(52) U.S. Cl. CPC G02B 6/3853; G02B 6/3874; G02B 1/11; G02B 6/2746

(57) ABSTRACT

An optical coupling apparatus includes a shell in which a sleeve that guides optical coupling is inserted; a ferrule into which an optical fiber collimator stub is inserted, wherein the optical fiber collimator stub is integrated into one with an optical fiber inserted inside the sleeve and converts an optical signal into a collimated beam; and a housing that surrounds the ferrule.

### CROSS-REFERENCE TO RELATED APPLICATION(S)

This application claims the benefit under 35 U.S.C. §119(a) of Korean Patent Application No. 10-2015-0013767, filed on Jan. 28, 2015, in the Korean Intellectual Property Office, the entire disclosure of which is incorporated herein by reference for all purposes.

### BACKGROUND

1. Field

The following description relates to an optical communications system and more particularly to an apparatus for optical coupling a transmitting and receiving module to an external device.

2. Description of the Related Art

A transmitter optical sub-assembly (TOSA) and a receiver optical sub-assembly (ROSA) used in an optical communications system employ a receptacle for the optical coupling to an external device. The receptacle includes single-mode optical fiber stub and ferrule in general. Optical coupling between such a receptacle and an optical element that exists inside an optical transmitting and receiving module (TOSA and ROSA) is performed through a lens.

An optical transmitting module (application No. U.S. Ser. No. 13/720,512), which an American optical module manufacturer, Finisar Corporation, filed in U.S., is of a TO-can package form and has a structure in which the optical coupler is optical-coupled to the external device by a receptacle. Here, a single lens is optical-coupled in general so as to optical-couple a laser diode (LD) to a single-mode optical fiber stub. In addition, an optical module (application No. U.S. Ser. No. 12/498,610), which Japanese Sumitomo Electric Industries, Ltd. filed in U.S., uses a TO-can package and has a single-lens optical coupling structure. These optical receiving modules are assembled using active optical alignment assembly equipment, and have disadvantages of a small allowable alignment error.

### SUMMARY

Provided is an optical coupling apparatus including an optical transmitting and receiving module, which enhances an allowable alignment error.

Also, provided is an optical coupling apparatus including an optical transmitting and receiving module, which has a tolerance in a manufacturing tolerance of equipment.

In one general aspect, an optical coupling apparatus includes: a shell in which a sleeve that guides the optical coupling is inserted; a ferrule into which an optical fiber collimator stub is inserted, wherein the optical fiber collimator stub is integrated into one with an optical fiber inserted inside the sleeve and converts an optical signal into a collimated beam; and a housing that surrounds the ferrule.

Other features and aspects may be apparent from the following detailed description, the drawings, and the claims.

### BRIEF DESCRIPTION OF THE DRAWINGS

FIG. 1A is a diagram illustrating an example of a receptacle that processes an optical receiving signal.

FIGS. 1B and 1C are diagrams illustrating examples of an optical receiving module to which a receptacle is coupled.

FIG. 2A is a diagram illustrating an example of a receptacle that processes an optical transmitting signal.

FIG. 2B is a diagram illustrating an example of an optical transmitting module to which a receptacle is coupled.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The present disclosure adopts a multi-lens optical coupling structure, to which a receptacle including an optical fiber collimator is applied, and proposes an optical coupling apparatus including an optical transmitting and receiving module that enhances an allowable alignment error and has a tolerance in a manufacturing tolerance of equipment, compared to a single-lens optical coupling structure that is generally used.

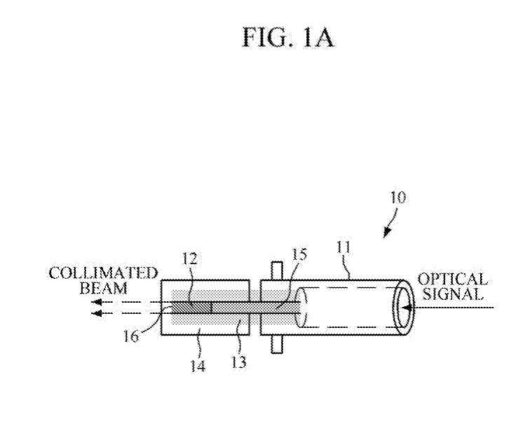

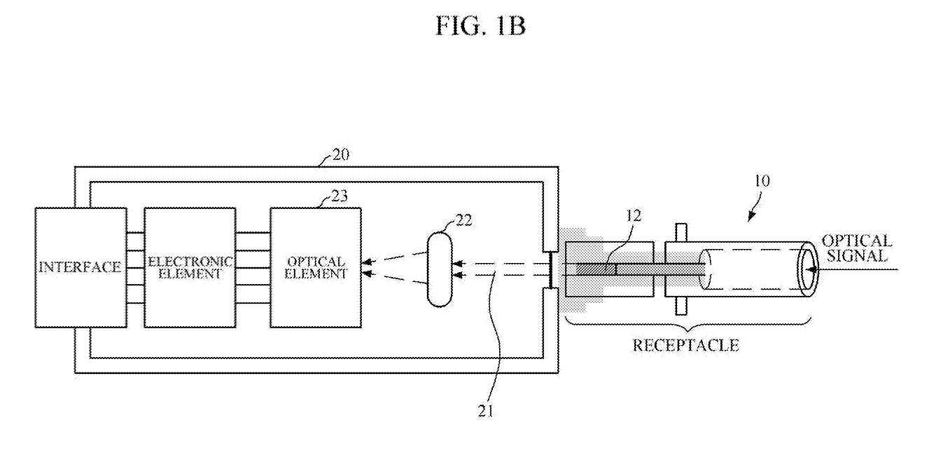

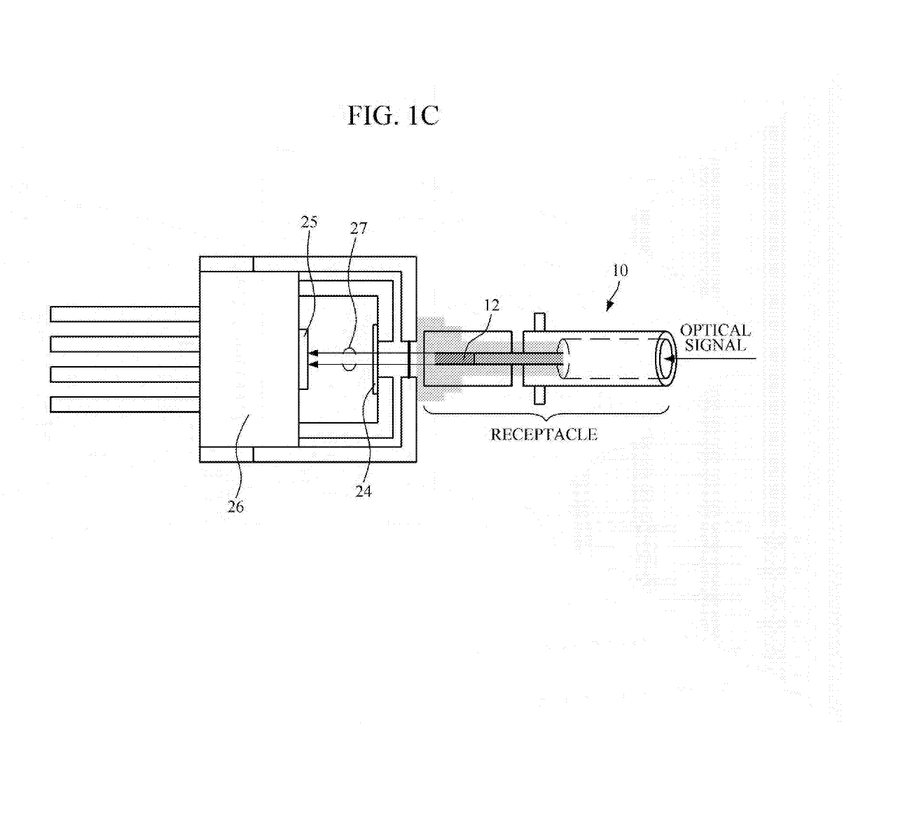

FIGS. 1A, 1B, and IC illustrate structures of a receiver optical sub-assembly (ROSA), wherein FIG. 1A illustrates a receptacle and each of FIGS. 1B and 1C illustrates an optical module to which a receptacle is coupled.

Referring to FIG. 1A, a receptacle includes a shell 11 to which a sleeve guiding the optical coupling is inserted, a ferrule 13 into which an optical fiber collimator stub 12 is inserted, and a housing 14 surrounding the ferrule 13.

The optical fiber collimator stub 12 includes a collimator that can be integrated as one body in a single-mode optical fiber or multi-mode optical fiber 15. The collimator 12 is a collimating lens that can be manufactured as one in the same standard as a gradient-index (GRIN) lens or a general optical fiber. One end 16 of the optical fiber collimator may be flat or have an angled edge with a predetermined angle. Also, the one end 16 may be anti-reflection (AR) coated.

Referring to FIG. 1B, a receptacle 10 illustrated in FIG. 1A is coupled to an optical receiving module 20, and an optical signal is applied to the optical receiving module 20 through the receptacle 10 from the outside. The applied optical signal is converted to a collimated beam 21 by an optical fiber collimator 12 inside the receptacle 10.

The generated collimated beam 21 is headed to a relatively long distance while not being spread out, and is optical-coupled to an optical element (passive element or active element) 23 through an optical coupling lens 22. Here, an alignment error between an optical fiber collimator 12 and the optical coupling lens 22 provides a tolerance to a manufacturing tolerance of equipment for an allowable alignment error, bigger compared to a single-lens structure, and the alignment. The optical coupled lens performs concentrating the incident collimated beam on one point. Such a lens may be made of an aspherical lens, a ball lens, or a GRIN lens.

FIG. 1C shows an example of applying, to a TO-can package 26, a structure without an optical coupling lens used in FIG. 1B. As shown in FIG. 1C, an optical signal that has been input to a receptacle 10 manufactured with an optical fiber collimator 12 is converted to collimated beams 27 through an optical fiber collimator 12, and then for the working wavelength, the collimated beams 27 pass a hermetically sealed window 24 made of a transparent material. Then, the collimated beams 22 are concentrated on a photodiode 25 without an additional lens for optical-coupling, and an electronic signal is output outwards through an optically-electronically conversion process. At this time, if a lens is formed in the photodiode chip that is being used, an optical coupling efficiency and an allowable optical alignment error may be improved more. Although not illustrated in FIG. 1C, a transimpedance amplifier (electronic component) that converts the output current signal of the photodiode to a voltage signal may be positioned.

Especially, the receptacle 10 is applicable to silicon photonics being a technical issue in a recent optical communications. Since an optical waveguide of silicon photonics has a big difference in the refractive index of materials between a core layer and a clad layer, if the optical-coupling lens is designed to have the numerical aperture (NA) of the optical-coupling lens, the silicon photonics chip is optical-coupled to the outside.

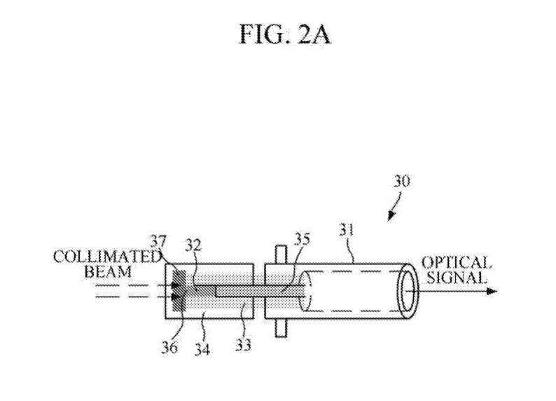

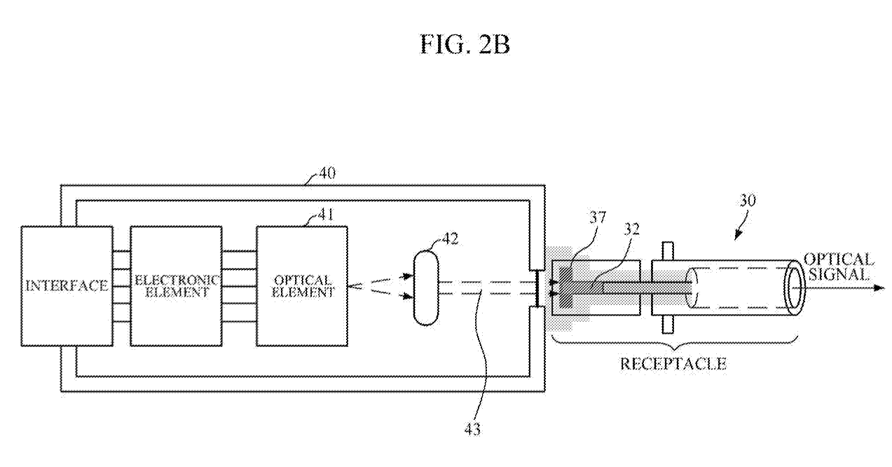

FIGS. 2A and 2B illustrate structures of a transmitter optical sub-assembly (TOSA), wherein FIG. 2A illustrates a receptacle and FIG. 2B illustrates an optical module to which a receptacle is coupled.

Referring to FIG. 2A, a receptacle 30 includes: a shell 31 to which a sleeve guiding the optical coupling is inserted; a ferrule 33 into which an optical fiber collimator stub 32 is inserted; an optical isolator 37 mounted on the end of the ferrule 33 so as to prevent the reflected optical signal from flowing as a light source; and a housing that surrounds the optical isolator 37.

The optical fiber collimator stub 32 includes a collimator that can be integrated as one body in a single-mode optical fiber or multi-mode optical fiber 35. The collimator 32 is a collimating lens that can be manufactured as one in the same standard as a gradient-index (GRIN) lens or a general optical fiber. One end 36 of the optical fiber collimator can be flat or have an angled edge with a desired angle and may be anti-reflection (AR) coated.

Referring to FIG. 2B, an optical signal is output from an optical element 41 that receives an electronic signal from the outside and electronically operates. Collimated beams 43 are generated from the output optical signal through a collimating lens 42 so as to be optical-coupled to a receptacle 30 and connected to the outside.

As described above, the generated collimated beams are headed to a relatively long distance while not being spread out, and is optical-coupled to an optical fiber through an optical coupling lens on a side of the optical fiber collimator.

Here, an alignment error between the collimating lens 42 positioned inside the module and the optical fiber collimator provides a tolerance to a manufacturing tolerance of equipment for an allowable alignment error, bigger compared to a single-lens structure, and the alignment. The collimating lens 42 inside an optical receiving module 40 generates the optical signals, output from the optical element (passive element or active element) 41, into collimated beams. Such a lens may be made of an aspherical lens, a ball lens, or a GRIN lens.

Especially, the receptacle is applicable to silicon photonics being a technical issue in a recent optical communications. Since an optical waveguide of silicon photonics has a big difference in the refractive index of materials between a core layer and a clad layer, if the optical-coupling lens is designed to have the numerical aperture (NA) of the optical-coupling lens, the silicon photonics chip is optical-coupled to the outside. An optical isolator may be, of course, integrated within a silicon photonics chip; however, the optical isolator may be integrated outside the silicon photonics chip as proposed in the present disclosure.

According to the configuration of the present disclosure, when an optical transmitting and receiving module is implemented, a receptacle that is implemented including an optical fiber collimator is applied so that an alignment error between a lens, positioned inside the module, and an optical fiber collimator provides a tolerance to a manufacturing tolerance of equipment for an allowable alignment error, bigger compared to a single-lens structure, and the alignment.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical coupling apparatus, comprising:
a shell in which a sleeve that guides optical coupling is inserted;
a ferrule into which an optical fiber collimator stub is inserted, wherein the optical fiber collimator stub is integrated into one with an optical fiber inserted inside the sleeve and converts an optical signal into a collimated beam; and
a housing that surrounds the ferrule.

2. The optical coupling apparatus of claim 1, wherein the optical fiber is a single-mode optical fiber or a multi-mode optical fiber.

3. The optical coupling apparatus of claim 1, wherein the collimator is a collimating lens that is manufactured as one in a same standard as a gradient-index (GRIN) lens or a general optical fiber.

4. The optical coupling apparatus of claim 1, wherein one end of the optical fiber collimator is flat or has an angled edge with a predetermined angle.

5. The optical coupling apparatus of claim 1, wherein the optical fiber collimator is anti-reflection (AR) coated.

6. The optical coupling apparatus of claim 1, wherein on one end of the ferrule, an optical isolator to prevent a reflected optical signal from flowing as a light source is mounted.
